(19) United States
(12) Patent Application Publication
(10) Pub. No.: US 2008/0261012 A1
(43) Pub. Date: Oct. 23, 2008

(54) Heat-reflecting adhesive tape

(75) Inventors: Patrick Kopf, Hamburg (DE); Ronald Pfaff, Hamburg (DE); Heike Moller, Hamburg (DE)

Correspondence Address: NORRIS, MCLAUGHLIN & MARCUS, 875 THIRD AVE, 18TH FLOOR, NEW YORK, NY, 10022, US

(73) Assignee: TESA AG, Hamburg (DE)

(21) Appl. No.: 12/052,558

(22) Filed: Mar. 20, 2008

(30) Foreign Application Priority Data
Apr. 17, 2007 (DE) 102007018381.1

(51) Int. Cl. B32B 33/00; H01B 13/26

(52) U.S. Cl. 428/222; 428/293.4; 428/336; 156/53

(57) ABSTRACT

Heat-reflecting adhesive tape (1), preferably for wrapping elongate material such as, more particularly, leads or cable harnesses, having a tapelike backing (2) composed of an assembly comprising at least one first layer (2a), formed by a glass fabric having a basis weight of 30 to 200 g/m², and at least one second layer (2b), formed by a metallic layer having a thickness of 10 to 40 μm and a thermal effectiveness to SAE J2302 at 350° C. of greater than 45° C., and having a pressure-sensitive adhesive coating (3) applied at least to one side of the backing (2), the flexural rigidity of the adhesive tape in longitudinal and transverse direction being less than 500 mN, preferably less than 300 mN (as measured with a Softometer KWS basic 2000 mN from Wolf).

### BACKGROUND OF THE INVENTION

The invention relates to a heat-reflecting adhesive tape, preferably for wrapping elongate material such as, more particularly, leads or cable harnesses, having a tapelike backing composed of an assembly of at least one first layer, formed by a glass fabric, and at least one second layer, formed by a metallic layer, and having a pressure-sensitive adhesive coating applied at least to one side of the backing. The invention further relates to the use of the adhesive tape and also to a cable loom jacketed with the adhesive tape of the invention.

In numerous sectors of industry, bundles composed of a multiplicity of electrical leads are wrapped, either before installation or when already mounted, in order to reduce the space taken up by the bundle of leads, by means of bandaging, and also to obtain protective functions. With sheet adhesive tapes a certain protection against ingress of liquid is achieved; with airy and bulky adhesive tapes based on thick nonwovens or foam backings, damping properties are obtained; and when stable, abrasion-resistant backing materials are used, a protective function against scuffing and rubbing is achieved.
a. Protection against radiant heat, however, is not offered by such adhesive tapes.

In order to demonstrate a material of construction's compliance with the existing requirements for electrical leads and other components for cable harnesses, a variety of checks and tests are prescribed, and have been summarized in forms which include a works standard agreed between different car makers (LV 112—low-voltage leads for motor vehicles, June 2004 version). According to this standard, the material of construction used for insulating the leads shall meet the requirements of VDA 231-106. The minimum and maximum sustained use temperatures (T_{U} and T_{O}) for an exposure time of 3000 h are −40° C. and 100° C. for classification into temperature class B, for example, the material having to withstand a short-term temperature (240 hours) of 125±3° C. and an overload temperature (6 hours) of 150±3° C.
a. For the purpose of specifying their maximum sustained use temperature, electrical leads and other components for cable harnesses are divided into temperature classes. This division into temperature classes is general knowledge and is shown once again in codified form in the following table:

| | Sustained use temperature | Short-term temperature | Temperature for thermal overload |
|---|---|---|---|
| Class | Tᵤ to Tₒ in ° C. | (Tₒ + 25)° C. | (Tₒ + 50)° C. |
| A | −40 to 85 | 110 ± 2 | 135 ± 3 |
| B | −40 to 100 | 115 ± 3 | 150 ± 3 |
| C | −40 to 125 | 150 ± 3 | 175 ± 3 |
| D | −40 to 150 | 175 ± 3 | 200 ± 3 |
| E | −40 to 175 | 200 ± 3 | 225 ± 3 |
| F | −40 to 200 | 225 ± 4 | 250 ± 4 |
| G | −40 to 225 | 250 ± 4 | 275 ± 4 |
| H | −40 to 250 | 275 ± 4 | 300 ± 4 |

Protection against radiant heat is generally accomplished by means of insulating layers having a low thermal conductivity. In the case of cable harnesses, this end is frequently served by recourse to temperature-resistant sleeves such as convoluted tubes, silicone hoses or metal-armoured glass fabric hoses, which, however, do not afford adequate protection for relatively high loads.

For specialty applications there also exist what are known as heat reflection tapes, which are adhesive tapes of the type specified at the outset. These tapes are composed of a glass fibre fabric (second backing layer) which is laminated with an aluminium foil (first backing layer) and provided on the reverse with a highly temperature-resistant silicone adhesive. Products of this kind are offered, for example, by the companies Tyco and Aremco, N.Y. Disadvantages of these tape products, however, include the high rigidity of the backing and also the high price as compared with conventional adhesive tapes.

EP 1 615 238 A1 discloses a thermally insulating adhesive tape for the wrapping of elongate material such as, more particularly, leads or cable harnesses, which has a tapelike backing. The backing is composed of an assembly of at least one first layer and at least one second layer, the first layer being a metallic layer. On one side of the backing a pressure-sensitive adhesive coating is applied. The second layer of the backing is formed by a polymeric film which is resistant up to a temperature of at least 175° C. or by a textile backing material which is resistant up to a temperature of at least 175° C.

Adhesive tapes of this kind, also called heat reflective adhesive tapes, are known. Since for the thermal reflection effect the adhesive tapes are wrapped with an overlap around cables, for example, the rigidity of the known adhesive tapes, which is attributable more particularly to the thick metal layers used, has a particularly negative effect.
a. Moreover, the unwind force of the adhesive tapes is high, resulting in an increased wrapping pressure, and the cable harness becomes particularly inflexible and exhibits disadvantageous properties for transit and installation.
b. The slower wrapping operation that is a result of this leads to higher costs.

Additionally there are aluminized or aluminium-clad braided hoses known (from Bentley Harris, for example), but in application these hoses again produce a cable harness of very low flexibility.

An established method of determining the abrasion resistance of protection systems in vehicle electrics is the international standard ISO 6722, section 9.3 “Scrape abrasion test” (April 2002 version). In this test the test specimen (for example the insulated copper lead or else the wrapping tape adhered to a metal mandrel) is exposed to a thin steel wire under a defined weight load and with defined stroke geometries until the protective casing has been rubbed through and, as a result of a short circuit, the counter which runs at the same time comes to a stop.

Unless indicated otherwise, all details relating to abrasion resistance refer to this ISO 6722 method. For that purpose the adhesive tape is adhered in a single ply in the longitudinal direction on a metal mandrel 10 mm in diameter; the scraping motion takes place centrally on the adhesive tape under a weight load of 7 N. The rubbing body used is a steel wire complying with ISO 8458-2, of 0.45 mm in diameter. The parameter for the abrasion resistance is the number of strokes until shortcircuiting occurs. In cases of very high scuff resistance, the mass that is applied can be increased in order to reduce the measurement time and the number of strokes. In this case an applied weight of 10 N has proved to be favourable.

The physical measurement of the sound damping effect is made in accordance with the method described in detail in DE 100 39 982 A1. This is a measurement methodology which is established in the automotive industry, and, for example, is also specified in the BMW standard GS 95008-3 (May 2000 version).

The measurement method according to the BMW standard GS 95008-3 from May 2000 is set out comprehensively below in conjunction with FIGS. 1 and 2.

FIG. 1 shows the construction of the measuring apparatus in side elevation, and

FIG. 2 shows the same construction in horizontal elevation.

In this measurement method a defined steel rod 1 with a diameter of 8 mm is wrapped with the test specimen 2—that is, adhesive tape—so as to produce lever lengths of 220 mm and 150 mm. The wrapped steel rod 1 is taken up to the stop 3, to the height of drop, and is dropped with a weight of approximately 16 g onto an aluminium panel 5. The aluminium panel 5, which in the unreformed state measures 350×190×0.3 [mm], is arranged in the form of a half-barrel under the test specimen 2, so as to give an extent of 290 mm.
a. The overall noise outcome is detected and recorded by means of a microphone 4, located over the test setup, in a frequency range of, for example, 20 to 12 500 Hz, using a commercial sound meter, for example of type 2226 from Bruel & Kjaer. Particularly relevant for the human ear are frequencies in the range from 2000 to 5000 Hz.
b. The damping is reported as the difference between the blank value, with the unwrapped steel rod, and the respective measurement value, in dB(A).

### SUMMARY OF THE INVENTION

It is an object of the invention to provide a heat-reflecting adhesive tape which when used to jacket cables, for example, not only provides the high level of heat reflection but at the same time also ensures a wrapped product, in this case a cable loom, therefore, which is more flexible than the existing products wrapped with the known adhesive tapes.

This object is achieved by means of an adhesive tape as characterized more closely in the main claim. The dependent claims describe advantageous embodiments of the invention. Further embraced by the concept of the invention are the use of the adhesive tape of the invention, and also a cable loom jacketed with the adhesive tape.

The invention accordingly provides a heat-reflecting adhesive tape, preferably for wrapping elongate material such as, more particularly, leads or cable harnesses, having a tapelike backing composed of an assembly comprising at least one first layer, formed by a glass fabric having a basis weight of 30 to 200 g/m², and at least one second layer, formed by a metallic layer having a thickness of 10 to 40 μm and a thermal effectiveness to SAE J2302 at 350° C. of greater than 45° C., and having a pressure-sensitive adhesive coating applied at least to one side of the backing.
a. The flexural rigidity of the adhesive tape in longitudinal and transverse direction is less than 500 mN, preferably less than 300 mN (as measured with a Softometer KWS basic 2000 mN from Wolf).

For the purposes of this invention the general expression adhesive tape encompasses all sheetlike structures such as two-dimensionally extended films or film sections, tapes with extended length and limited width, tape sections, dicuts, labels and the like.

According to one advantageous embodiment of the invention the adhesive coating is applied on the open side, opposite the second layer, of the first layer.

With further preference siliconization, at with particular preference 0.5 g/m² to 1.5 g/m², with very particular preference 1 g/m², is applied to the open side, opposite the first layer, of the second layer, this siliconization more particularly being of polysiloxane.
a. This coating of silicone release varnish permits very easy and uniform unwinding of the adhesive tape of the invention in use. As a result, the advantage is produced that it is possible to forego the use of a release paper or release film.
b. Suitable coatings include the typical polysiloxane release varnish coating, for example from Wacker, Rhodia or Dow Corning. Solvent-based, emulsion-based or 100%-system coatings are suitable. These polysiloxane coatings are crosslinked typically through an addition reaction or through a condensation reaction. It is advantageous to use a polysiloxane system with very easy release for the coating.

The flexural rigidity of the backing and hence of the adhesive tape, according to a further advantageous embodiment of the invention, is less than 230 mN in the longitudinal direction and less than 150 mN in the transverse direction (as measured with a Softometer KWS basic 2000 mN from Wolf).

The properties of the glass fabric of the first layer are advantageously as follows:
the basis weight is from 80 to 120 g/m².
the number of filaments in longitudinal and transverse direction is in each case 3 to 10 filaments/cm; and/or
the filaments used to form the glass fabric have a linear density of less than 150 tex, preferably less than 100 tex.

According to a further advantageous embodiment of the invention the metallic layer has a thickness of 12 to 20 μm. Where appropriate it further comprises embossing.

Metals which can be chosen include silver, copper, gold, platinum, aluminium and compounds of aluminium, tin, Nichrome, NIROSTA, titanium, and metal oxides such as cadmium oxides, tin oxides, zinc oxides and magnesium oxides, but preferably aluminium. This list is not regarded as being conclusive instead, the skilled person is able to choose further metal layers, not explicitly specified here, without departing from the concept of the invention.

In order to produce a self-adhesive tape from the backing it is possible to employ all known adhesive systems. Besides natural or synthetic rubber based adhesives it is possible more particularly to use silicone adhesives and also polyacrylate adhesives. Preferred on account of their particular suitability as an adhesive for wrapping tapes for automotive cable harnesses, in respect of the absence of fogging and also the outstanding compatibility with both PVC and PVC-free core insulations, are solvent-free acrylate hotmelt compositions, as described in more detail in DE 198 07 752 A1 and also DE 100 11 788 A1.
a. The application weight is situated in the range between 20 to 100 g/m².
b. The coating technology employed involves known systems, appropriate processes being those which permit an unpressurized placement of highly viscous adhesives—such as, for example, the coating of hotmelt adhesives via nozzle coating or via transfer from an anti-adhesive support cloth or release liner onto the backing assembly.

A suitable adhesive is one based on acrylate hotmelt with a K value of at least 20, more particularly greater than 30 (measured in each case in 1% strength solution in toluene, 25° C.), obtainable by concentrating a solution of such a composition to give a system which can be processed as a hotmelt.
a. Concentration may take place in appropriately equipped tanks or extruders; more particularly in the case of accompanying devolatilization, a devolatilizing extruder is preferred.
b. One such adhesive is set out in DE 43 13 008 C2. In an intermediate step, the solvent is removed completely from the acrylate compositions prepared in this way.
c. The K value is determined more particularly in analogy to DIN 53 726.

Additionally, in the course of this process, further volatile constituents are removed. After coating from the melt, these compositions have only small residual fractions of volatile constituents. Accordingly it is possible to take on all of the monomers/formulas that are claimed in the patent cited above.
a. The solution of the composition may contain 5% to 80% by weight, more particularly 30% to 70% by weight, of solvent.
b. Preference is given to using commercially customary solvents, more particularly low-boiling hydrocarbons, ketones, alcohols and/or esters.
c. Further preference is given to using single-screw, twin-screw or multi-screw extruders having one or, more particularly, two or more devolatilizing units.
d. The acrylate hotmelt-based adhesive may have had benzoin derivatives incorporated into it by copolymerization: for example, benzoin acrylate or benzoin methacrylate, acrylic or methacrylic esters. Benzoin derivatives of this kind are described in EP 0 578 151 A.
e. The acrylate hotmelt-based adhesive may be UV-crosslinked. Other types of
   crosslinking are also possible, however, an example being electron beam crosslinking.
f. In a further preferred embodiment the self-adhesive compositions employed are copolymers of (meth)acrylic acid and the esters thereof having 1 to 25 C atoms, maleic, fumaric and/or itaconic acid and/or their esters, substituted (meth)acrylamides, maleic anhydride and other vinyl compounds, such as vinyl esters, more particularly vinyl acetate, vinyl alcohols and/or vinyl ethers.
g. The residual solvent content ought to be below 1% by weight.

One adhesive which is found to be particularly suitable is a low molecular mass, pressure-sensitive, acrylate hotmelt adhesive of the kind carried under the name acResin UV or Acronal®, more particularly Acronal DS 3458, by BASF. This adhesive, with a low K value, acquires its application-compatible properties through a concluding, radiation-induced crosslinking operation.

Preferably, therefore, the adhesive coating is composed of an adhesive comprising acrylate or silicone.

The adhesive may be applied in the longitudinal direction of the adhesive tape, in the form of a stripe whose width is lower than that of the adhesive tape backing.
a. In one advantageous embodiment the coated stripe has a width of 10% to 80% of the width of the backing material. Particular preference is given to using stripes having a coating of 20% to 50% of the width of the backing material.
b. Depending on the particular utility it is also possible for two or more parallel stripes of the adhesive to be coated on the backing material.
c. The position of the stripe on the backing is freely selectable, preference being given to an arrangement directly at one of the edges of the backing.

Furthermore, the first layer and/or the adhesive coating may have been made flame retardant by means, for example, of a flame retardant composed of ammonium polyphosphate, magnesium hydroxide and/or aluminium hydroxide or by means of a chlorinated paraffin, where appropriate in combination with antimony trioxide.

The adhesive tape may preferably have an abrasion resistance to ISO 6722 on single-ply measurement which is such as to withstand a number of strokes of more than 500, more particularly of 800 to 2500.

The adhesive tape may then exhibit sound damping to BMW GS 95008-3 on single-ply measurement of more than 3 dB (A), more particularly 5 dB (A) to 6 dB (A).

The adhesive tape is preferably hand-tearable at least in the transverse direction.

The adhesive tape is preferably used for jacketing elongate material such as, more particularly, cable harnesses, the elongate material being wrapped in axial direction by the adhesive tape, or the adhesive tape being guided in a helical spiral around the elongate material.

Also embraced by the concept of the invention, finally, is an elongate material, such as, more particularly, a cable harness, which is jacketed with the adhesive tape of the invention.

With reference to the figures described below, the adhesive tape of the invention is elucidated in more detail in one particularly advantageous embodiment, without wishing thereby to restrict the invention.

### BRIEF DESCRIPTION OF THE DRAWINGS

In the drawings, wherein like reference numerals delineate similar elements throughout the several views:

FIG. 3 shows the adhesive tape of the invention in side-on section;

FIG. 4 Shows the use of the adhesive tape of the invention in another embodiment in association with the jacketing of cables, or a cable loom.

### DETAILED DESCRIPTION OF THE PRESENTLY PREFERRED EMBODIMENTS

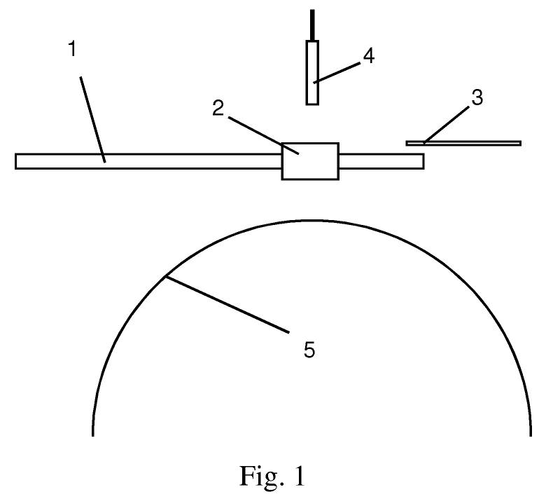

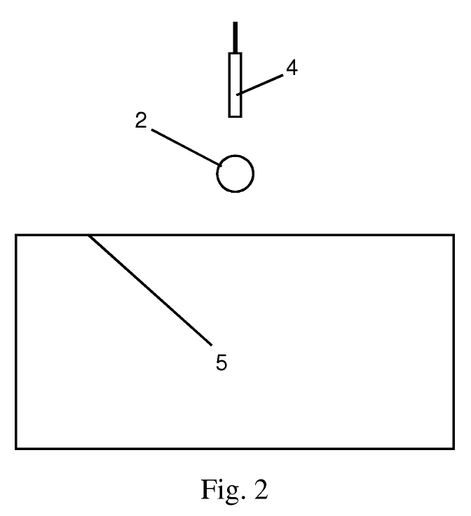

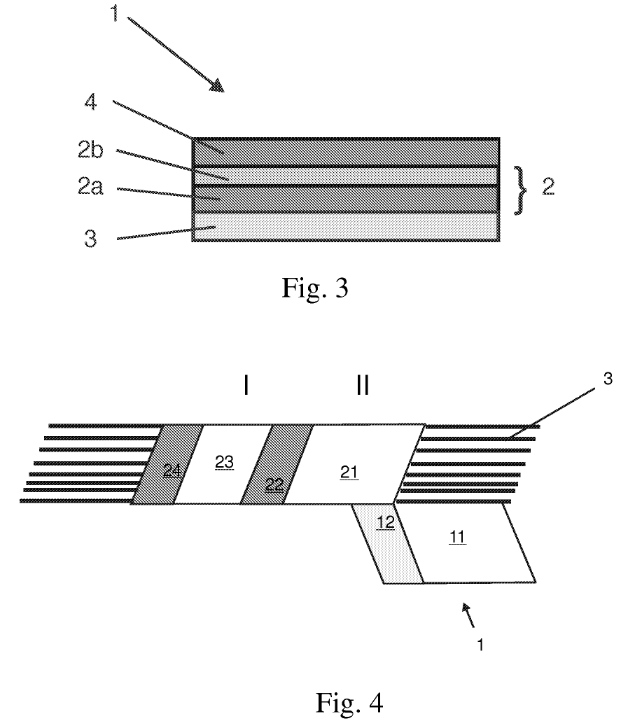

Referring now to FIG. 3, a heat-reflecting adhesive tape (1) of the invention comprises a tapelike backing (2) which is composed of an assembly of at least one first layer (2a), formed by a glass fabric having a basis weight of 30 to 200 g/m², and at least one second layer (2b), formed by a metallic layer having a thickness of 10 to 40 μm and a thermal effectiveness to SAE J2302 at 350° C. of greater than 45° C.
a. Applied on one side of the backing (2) is a pressure-sensitive adhesive coating (3).
b. Applied to the open side, opposite the first layer (2a), of the second layer (2b) is a siliconization (4).

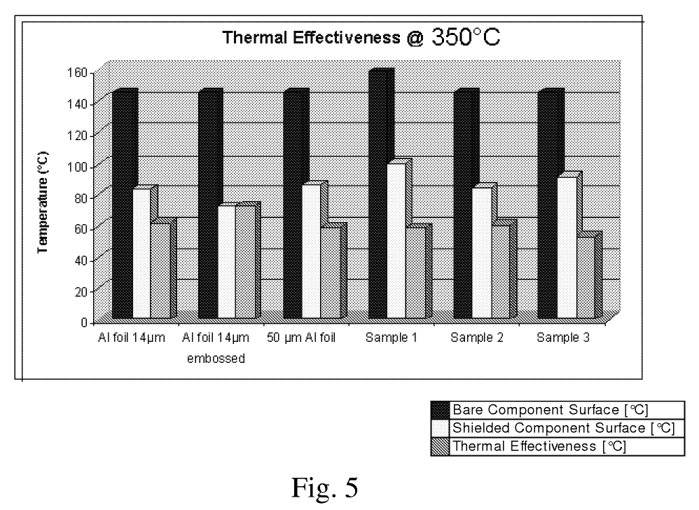

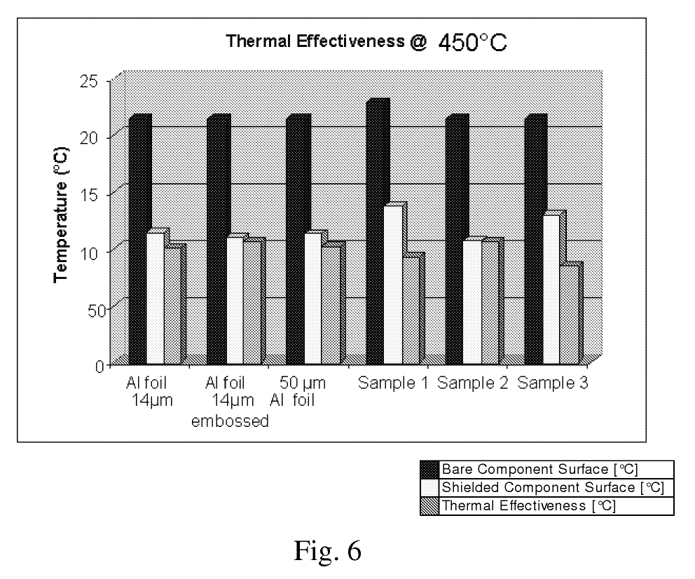

FIG. 4 shows a section of a cable loom which is composed of a bundle of individual cables 7 and which is jacketed with the adhesive tape 1 of the invention. The adhesive tape 1 is guided in a spiral motion around the cable loom.
a. The section of the cable loom that is shown has two winds I and II of the adhesive tape 1. Further winds would extend towards the left; these are not shown here.
b. The backing material 11, 21, 23 is coated on one side with an adhesive 12, 22, 24, application taking place in the form of a stripe in the longitudinal direction, the width of the stripe being lower than that of the backing material 11, 21, 23 of the adhesive tape 1.
c. The cable loom is jacketed in such a way that the stripe of adhesive 12, 22, 24 adheres fully to the backing material 11, 21, 23 of the adhesive tape 1. Sticking to the cables 7 is not possible.
d. The adhesive tape 1 embraces (see wind 1) in its width the section 24 and the section 22, and also the open backing 23 located in-between them. The section 22, which belongs to the wind II, therefore adheres to the section 23. (The section 24 would adhere to the backing of the next wind situated to the left.) In contrast to the exposed adhesive 12, the sections 22 and 24 are not visible from the outside, which is why the denser shading has been chosen to depict them.

Surprisingly, and unexpectedly to a person skilled in the art, the adhesive tape of the invention displays the feature, in spite of the very much thinner metal layer as compared with the known tapes, of providing outstanding heat reflection.
a. At the same time the thin metal layer is also responsible for the adhesive tape leading to far more flexible products when they are jacketed with the adhesive tape.

This is also shown by the following comparative measurements.
a. The following materials were investigated:

14 μm aluminium foil

14 μm aluminium foil, embossed

50 μm aluminium foil (prior art)

thin glass fabric (100 g/m²) with a 17 μm aluminium foil (called Sample 1)

thin glass fabric (100 g/m²) with a 40 μm aluminium foil (called Sample 2)

thick glass fabric (330 g/m²) with a 40 μm aluminium foil (called Sample 3 and prior art)

The foils were measured separately and as an assembly with glass fabric, in a manner analogous to that in SAE J2302.

FIG. 5 shows the result of heat reflection, called thermal effectiveness at 350° C., while FIG. 6 shows the same at 450° C.

The key to the three bars arranged from left to right is as follows:

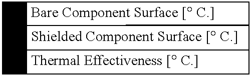

| | |
|---|---|
| a. Left (dark): | Temperature on the ceramic rod without tape |
| b. Middle (light): | Temperature on the outside of the tape |
| c. Right (medium): | Heat reflection capacity - thermal effectiveness |

It is found that the foil used in accordance with the invention and the backing used in accordance with the invention show no drop in performance as compared with the known systems, despite the very much thinner metal coating.

The superiority of the adhesive tape of the invention is manifested in association with the measurement of the flexural rigidity, which shows the effect of the aluminium foil on the flexibility.
a. Table 1 shows the flexural rigidities (FR) of the individual materials.

| | FR | FR |
|---|---|---|
| | longitudinal | transverse |
| Specimen | mN | mN |
| Sample 1 | 229 | 148 |
| Sample 2 | 498 | 295 |
| Sample 3 | 917 | 216 |
| Al foil | 225 | — |
| 50 μm | | |
| Al foil | 5 | — |
| 13 μm | | |
| Al foil | 6 | — |
| 13 μm | | |
| embossed | | |
| WB | 352 | 558 |
| specimen 1 | | |

The flexural rigidity is a measure of the flexibility of a backing or of a backing assembly.

A commercially customary aluminium foil has a flexural rigidity of 3 mN. In other words it is a very flexible material. A 50 μm aluminium foil, in contrast, possesses a flexural rigidity of 225 mN.
a. In other words, the flexural rigidity increases disproportionately to the thickness of the film.

The same glass fabric laminated with a 17 μm Al foil has a flexural rigidity of 229 mN, almost 500 nM when laminated with a 40 μm Al-foil, and more than 900 mN when laminated with a thick glass fabric.

In order to obtain a flexible adhesive tape having a good heat reflection capacity it is possible to select a very thin aluminium foil for the lamination of the glass fabric.

The adhesive tape of the invention is relatively easy to produce, yields a favourably priced heat protection tape, and then meets the requirement for sustained use temperatures up to class F (200° C.) according to SAE J 2192 or other relevant specifications, an example being the Fiat Auto Normazione Procurement Specification 9.91220 of 19 Dec. 2001, section 2.4.1, Flexibility test.

What is claimed is:

1. A heat-reflecting adhesive tape (1) For wrapping elongate material, comprising
a tapelike backing (2) composed of an assembly comprising at least one first layer (2a), formed by a glass fabric having a basis weight of 30 to 200 g/m², and at least one second layer (2b), formed by a metallic layer having a thickness of 10 to 40 μm and a thermal effectiveness to SAE J2302 at 350° C. of greater than 45° C., and having a pressure-sensitive adhesive coating (3) applied at least to one side of the backing (2), the flexural rigidity of the adhesive tape in longitudinal and transverse direction being less than 500 mN, preferably less than 300 mN (as measured with a Softometer KWS basic 2000 mN from Wolf).

2. The heat-reflecting adhesive tape according to claim 1, wherein the adhesive coating (3) is applied to an open side, opposite the second layer (2b) of the first layer (2a).

3. The heat-reflecting adhesive tape according to claim 1, wherein siliconization (4) is applied at 0.5 g/m² to 1.5 g/m² to the open side, opposite the first layer (2a), of the second layer (2b).

4. The heat-reflecting adhesive tape according to claim 1, wherein the flexural rigidity of the adhesive tape in the longitudinal direction is less than 230 mN and in the transverse direction is less than 150 mN.

5. The heat-reflecting adhesive tape according to claim 1, wherein the glass fabric of the first layer (2a) having a basis weight of 80 to 120 g/m²; and having 3 to 10 filaments/cm in longitudinal and transverse direction, and/or the filaments used to form the glass fabric have a linear density of less than 150 tex, preferably less than 100 tex.

6. The heat-reflecting adhesive tape according claim 1, wherein the metallic layer (2b) has a thickness of 12 to 20 μm.

7. The heat-reflecting adhesive tape according to claim 1, wherein the metallic layer (2b) is composed of aluminium.

8. The heat-reflecting adhesive tape according to claim 1, wherein the adhesive coating is composed of an adhesive comprising acrylate or silicone.

9. The heat-reflecting adhesive tape according to claim 1, wherein the first layer (2a) and/or the adhesive coating (3) are flame by treatment with ammonium polyphosphate, magnesium hydroxide and/or aluminium hydroxide or by means of a chlorinated paraffin, where appropriate in combination with antimony trioxide.

10. The heat-reflecting adhesive tape according to claim 1, wherein the adhesive tape has an abrasion resistance to ISO 6722 on single-ply measurement such as to withstand a number of strokes of more than 500.

11. The heat-reflecting adhesive tape according to claim 1, wherein the adhesive tape exhibits sound damping to BMW GS 95008-3 on single-ply measurement of more than 3 dB (A).

12. A method of using an adhesive tape according to claim 1 for providing a jacket to elongated material, comprising the steps of
wrapping the elongated material in the axial direction with the adhesive tape by guiding the elongated material in a helical spiral around the elongate material.

13. An elongate cable harness, comprising a jacket of an adhesive tape according to claim 1.

14. The heat-reflecting adhesive tape according to claim 3, wherein siliconization (4) is applied at 1 g/m².

15. The heat-reflecting adhesive tape according to claim 9, wherein the first layer (2a) and/or the adhesive coating (3) are flame by treatment with a chlorinated paraffin, where appropriate in combination with antimony trioxide.

16. The heat-reflecting adhesive tape according to claim 9, wherein the first layer (2a) and/or the adhesive coating (3) are flame by treatment with ammonium polyphosphate, magnesium hydroxide and/or aluminium hydroxide or by means of a chlorinated paraffin, and in combination with antimony trioxide.

17. The heat-reflecting adhesive tape according to claim 10, wherein the adhesive tape has an abrasion resistance to ISO 6722 on single-ply measurement such as to withstand a number of strokes of 800 to 2500.

18. The heat-reflecting adhesive tape according to claim 11, wherein the adhesive tape exhibits sound damping to BMW GS 95008-3 on single-ply measurement of more than 5 dB (A) to 6 dB (A).
